(19) United States
(12) Patent Application Publication
(10) Pub. No.: US 2017/0109679 A1
(43) Pub. Date: Apr. 20, 2017

(54) MULTIDIMENSIONAL INSIGHTS ON CUSTOMER SERVICE DYNAMICS

(71) Applicant: LinkedIn Corporation, Mountain View, CA (US)

(72) Inventors: Rui Zhao, Mountain View, CA (US); Chi-Yi Kuan, Fremont, CA (US); Jennifer E. Guenther, San Jose, CA (US); Narasimha R. Veeramreddy, San Jose, CA (US)

(73) Assignee: LINKEDIN CORPORATION, Mountain View, CA (US)

(21) Appl. No.: 14/887,208

(22) Filed: Oct. 19, 2015

(51) Int. Cl. G06Q 10/06; G06Q 30/00; H04L 12/26

(52) U.S. Cl. CPC G06Q 10/06393; H04L 43/16; G06Q 30/016

(57) ABSTRACT

The disclosed embodiments provide a system for processing data. During operation, the system obtains a set of key performance indicators (KPI) for one or more customer service representatives, wherein the set of KPIs includes a number of cases (e.g., solved cases, reopened cases, handled cases, and/or routed cases) per queue hour. Next, the system uses the set of KPIs to display a graphical user interface (GUI) comprising a chart of a two-dimensional performance measurement for the one or more customer service representatives. The system then displays, in the chart, a first axis representing a productivity KPI comprising the number of cases per queue hour and a second axis representing an additional KPI from the set of KPIs.

### RELATED APPLICATION

The subject matter of this application is related to the subject matter in a co-pending non-provisional application by the same inventors as the instant application and filed on the same day as the instant application, entitled “Multidimensional Characterization of Customer Service Dynamics,” having serial number TO BE ASSIGNED, and filing date TO BE ASSIGNED (Attorney Docket No. LI-P1673.LNK.US).

### BACKGROUND

Field

The disclosed embodiments relate to techniques for managing customer service representative performance. More specifically, the disclosed embodiments relate to techniques for providing insights on customer service dynamics.

Related Art

Customer service is an important component of customer relationship management and business operations. During a customer service interaction, a customer service representative may assist a customer with effective and correct use of a product. For example, the customer service representative may help the customer with planning, installing, training, troubleshooting, maintaining, upgrading, and/or disposing of the product. In turn, effective customer service interaction may increase revenue and customer satisfaction, and decrease churn and unproductive contact with customers.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 shows a schematic of a system in accordance with the disclosed embodiments.

FIG. 2 shows a performance-management system in accordance with the disclosed embodiments.

FIG. 3A shows an exemplary screenshot in accordance with the disclosed embodiments.

FIG. 3B shows an exemplary screenshot in accordance with the disclosed embodiments.

FIG. 4 shows a flowchart illustrating the processing of data in accordance with the disclosed embodiments.

FIG. 5 shows a flowchart illustrating the process of providing a graphical user interface (GUI) on a computer system in accordance with the disclosed embodiments.

FIG. 6 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

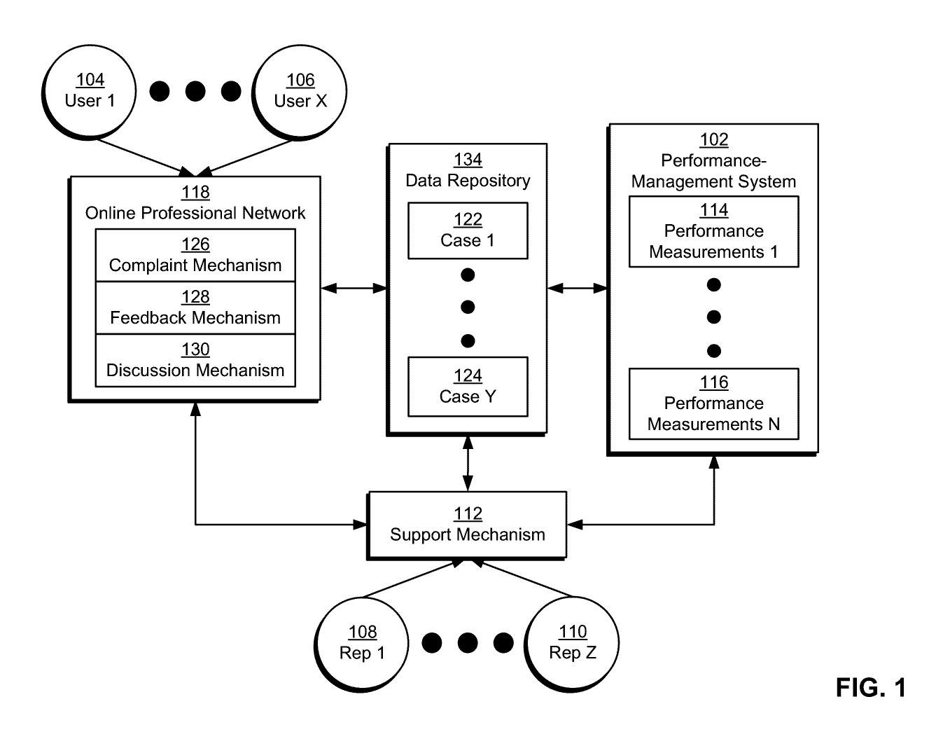

The disclosed embodiments provide a method, apparatus, and system for processing data. More specifically, the disclosed embodiments provide a method, apparatus, and system for providing multidimensional characterization and insights related to customer service dynamics. As shown in FIG. 1, customer service interaction may be associated with use of an online professional network 118 and/or another application or service by a set of users (e.g., user 1 104, user x 106). Among other benefits, online professional network 118 may allow the users to establish and maintain professional connections, list work and community experience, endorse and/or recommend one another, and/or search and apply for jobs. Employers and recruiters may use online professional network 118 to list jobs, search for potential candidates, and/or provide business-related updates to users.

During use of online professional network 118, the users may create a set of content items. The content items may include posts, updates, comments, sponsored content, articles, and/or other types of data transmitted or shared within online professional network 118.

The content items may additionally include complaints provided through a complaint mechanism 126, feedback provided through a feedback mechanism 128, and/or group discussions provided through a discussion mechanism 130 of online professional network 118. Complaint mechanism 126 may allow users to file complaints or identify issues associated with use of online professional network 118, such as complaints related to the free or paid use of online professional network 118, use of one or more products offered within online professional network 118, and/or security issues with online professional network 118. Feedback mechanism 128 may allow the users to provide scores representing the users' likelihood of recommending the use of online professional network 118 to other users, as well as feedback related to the scores and/or suggestions for improvement. Discussion mechanism 130 may obtain updates, discussions, and/or posts related to activity among groups of users in online professional network 118.

In one or more embodiments, complaints, feedback, discussions, and/or other content items related to customer service issues with online professional network are stored as customer service cases (e.g., case 1 122, case y 124) in a data repository 134. For example, each new complaint submitted through complaint mechanism 126 may be stored as a new customer service case in data repository 134. One or more customer service representatives (e.g., rep 1 108, rep z 110) may use a support mechanism 112 to access the complaint and interact with the user who submitted the complaint. For example, the customer service representative(s) may use one or more customer service tools included in support mechanism 112 to communicate with the user via chat, email, voice, and/or video. Records or transcripts of some or all interactions from support mechanism 112 may be included with the case in data repository 134. After the complaint has been adequately addressed, the case may be marked as solved in data repository 134, and user feedback (e.g., opinions, ratings, scores, etc.) related to the handling of the case by the customer service representative(s) may be obtained through feedback mechanism 128.

Those skilled in the art will appreciate that the effectiveness of customer service interaction through support mechanism 112 may vary with the training, experience, workload, and/or other attributes of the customer service representative conducting the interaction. For example, a newer customer service representative may take longer to resolve a complaint than an experienced customer service representative. Similarly, the effectiveness of a customer service representative at resolving customer service issues may directly impact customer satisfaction and retention with online professional network 118.

In one or more embodiments, the system of FIG. 1 includes functionality to characterize and manage the performance of customer service representatives in terms of multidimensional metrics. In particular, a performance-management system 102 may monitor interaction between the users and customer service representatives through support mechanism 112. For example, performance-management system 102 may aggregate data from different customer service teams and/or customer service tools (e.g., support mechanism 112) into metadata for cases in data repository 134 and/or another data store. As mentioned above, the data may include records and/or transcripts of interaction between the customer service representatives and users. The data may also include metrics associated with the interaction, such as metrics that characterize the efficiency and/or effectiveness of the customer service representatives.

Next, performance-management system 102 may use the metrics to assess the work quality of the customer service representatives in terms of both qualitative and quantitative performance measurements (e.g., performance measurements 1 114, performance measurements n 116). As described in further detail below, the qualitative performance measurements may include a customer satisfaction score (CSAT), and the quantitative performance measurements may include a number of cases per queue hour. The qualitative and quantitative performance measurements may then be combined into a two-dimensional performance measurement and/or aggregated into a performance score, and the performance of the customer service representatives may be assessed and/or managed accordingly.

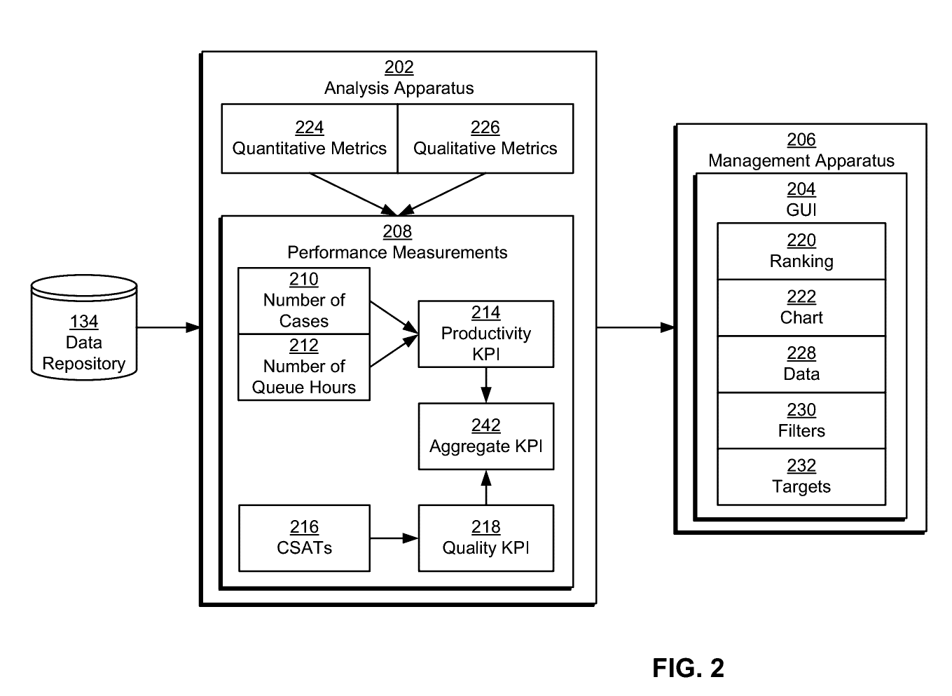

FIG. 2 shows a performance-management system (e.g., performance-management system 102 of FIG. 1) in accordance with the disclosed embodiments. As shown in FIG. 2, the system includes an analysis apparatus 202 and a management apparatus 206. Each of these components is described in further detail below.

Analysis apparatus 202 may calculate a set of performance measurements 208 for a number of customer service representatives, such as customer service representatives for online professional network 118 of FIG. 1 and/or customer service representatives for other products or services. To calculate performance measurements 208, analysis apparatus 202 may obtain a set of quantitative metrics 224 and/or a set of qualitative metrics 226 for each customer service representative from data repository 134.

Quantitative metrics 224 may include measurements of efficiency and/or productivity for the customer service representative. Quantitative metrics 224 may be collected by the performance-management system, a support mechanism (e.g., support mechanism 112 of FIG. 1), and/or another component that monitors the activity, interaction, and/or output of the customer service representative.

First, quantitative metrics 224 may track the time spent by the customer service representative on various tasks. For example, quantitative metrics 224 may include a number of queue hours 212 (e.g., number of hours related to customer-facing work), chat hours (e.g., number of hours spent on chat work with customers), ad review hours (e.g., number of hours spent reviewing advertisements for display to users), non-queue hours (e.g., number of hours consumed by meetings, breaks, training, and/or other non-customer-facing work), personal time off (PTO) or sick leave hours, and/or holiday hours logged by the customer service representative.

Second, quantitative metrics 224 may track the handling of a number of cases 210 (e.g., customer service cases from data repository 134) by the customer service representative. For example, quantitative metrics 224 may include the number of cases routed away from the customer service representative to a different customer service representative, the number of cases routed to the customer service representative from other customer service representatives, the number of open (e.g., unresolved) cases in the customer service representative's queue, the number of solved or closed cases in the customer service representative's queue, the number of cases handled by or assigned to the customer service representative, and/or the number of distinct solved or closed cases (e.g., in which a solved case is counted only once independently of the number of times it is reopened or subsequently resolved) in the customer service representative's queue.

Qualitative metrics 226 may represent subjective evaluations of the customer service representative's effectiveness and/or performance. For example, qualitative metrics 226 may include one or more CSATs 216 from feedback provided by users who have interacted with the customer service representative. CSATs 216 may include ratings, scores, and/or other scale-based assessments of the responsiveness, communicativeness, ability to resolve the users' issues, and/or other attributes of interaction with the customer service representative. CSATs 216 may also include a rating or score representing the users' overall experience with the customer service representative. CSATs 216 may further include feedback, scores, reviews, and/or ratings from colleagues, managers, and/or other individuals who interact with the customer service representative in a professional context.

Next, analysis apparatus 202 may use quantitative metrics 224 and qualitative metrics 226 to calculate a set of performance measurements 208 for the customer service representative. As shown in FIG. 2, performance measurements 208 may include a productivity key performance indicator (KPI) 214 that is calculated from number of cases 210 and number of queue hours 212. As mentioned above, number of cases 210 may include a number of solved cases, reopened cases, handled cases, and/or routed cases in the customer service representative's queue over a pre-specified period (e.g., a week, a month, etc.). Number of queue hours 212 may represent the number of hours spent on queue (e.g., customer-facing) work over the same period.

To calculate productivity KPI 214, analysis apparatus 202 may divide number of cases 210 by number of queue hours 212. For example, analysis apparatus 202 may divide a number of solved cases for the customer service representative over the previous week by the number of queue hours reported by the customer service representative over the same week to obtain a number of solved cases per queue hour as productivity KPI 214 for the customer service representative over the previous week. Analysis apparatus 202 may also calculate other variations of productivity KPI 214 as the number of reopened, handled, and/or routed cases per queue hour and/or other unit of activity for the customer service representative from quantitative metrics 224.

Performance measurements 208 may also include a quality KPI 218 that is calculated from one or more CSATs 216 and/or other qualitative metrics 226 related to the performance of the customer service representative. For example, quality KPI 218 may be calculated as an average CSAT for the customer service representative over a given week, month, and/or other pre-specified period. In another example, quality KPI 218 may be calculated as a weighted combination of different types of CSATs 216 and/or other scores or ratings of the customer service representative's performance over the period.

Analysis apparatus 202 may then combine productivity KPI 214 and quality KPI 218 into an aggregate KPI 242 for the customer service representative. Aggregate KPI 242 may represent a combination of both qualitative and quantitative measurements of performance for the customer service representative. For example, aggregate KPI 242 may include a performance score that is calculated as a weighted combination of productivity KPI 214, quality KPI 218, and/or other KPIs or metrics. In another example, aggregate KPI 242 may include a two-dimensional performance measurement that has productivity KPI 214 as one dimension and quality KPI 218 as the other dimension.

Performance measurements 208 may also include other KPIs and/or aggregate measurements of customer service representative performance. For example, performance measurements 208 may include the total number of hours logged by the customer service representative, which may be calculated by summing all logged time for a given customer service representative over a pre-specified period (e.g., a week). In another example, performance measurements 208 may include a reopen rate that is calculated by dividing the number of reopened cases by the number of solved cases for the customer representative. In a third example, performance measurements 208 may include a queue hour utilization that is calculated by dividing the number of queue hours by the total number of hours logged over a given period. In a fourth example, quantitative metrics 224 and/or qualitative metrics 226 may be provided as input to a linear, polynomial, trigonometric, hyperbolic, exponential, logarithmic, and/or other mathematical function, and one or more performance measurements 208 may be obtained as output from the function. In a fifth example, performance measurements 208 for individual customer service representatives may be summed, averaged, combined, and/or otherwise aggregated into overall performance measurements 208 for a given team, location, manager, hire status, queue-facing status, role, and/or other grouping of the customer service representatives. In turn, the overall performance measurements 208 may be used to establish benchmarks for evaluating performance within and/or across groups of customer service representatives.

After performance measurements 208 are calculated by analysis apparatus 202, management apparatus 206 may display information associated with quantitative metrics 224, qualitative metrics 226, and/or performance measurements 208 in a graphical user interface (GUI) 204. For example, management apparatus 206 may provide GUI 204 for use in characterizing, assessing, and managing the performance of customer service representatives in one or more organizations by management, executives, and/or other members of the organization(s).

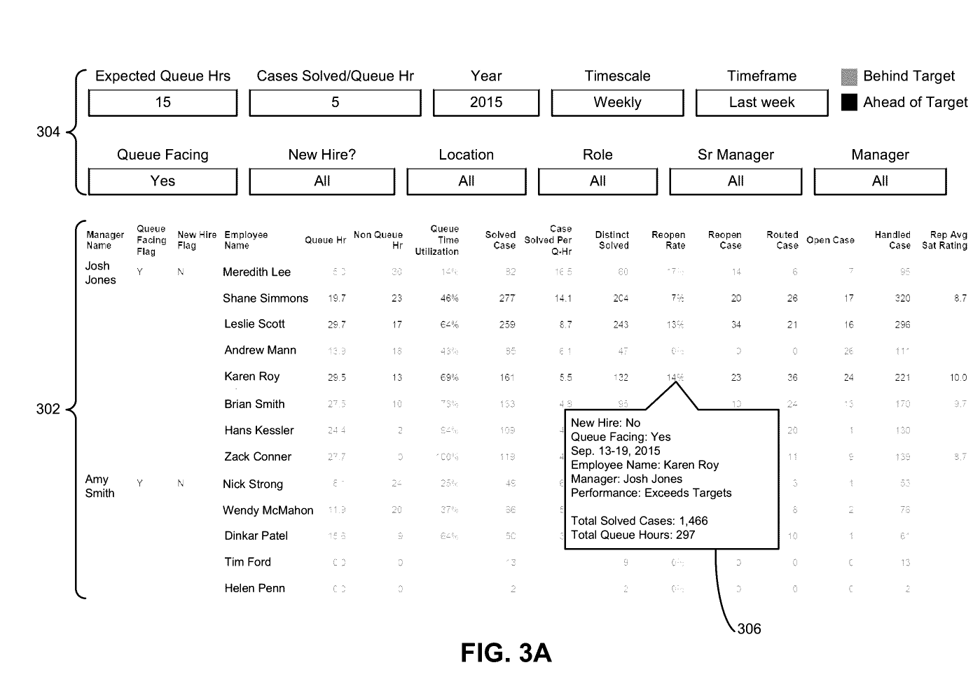

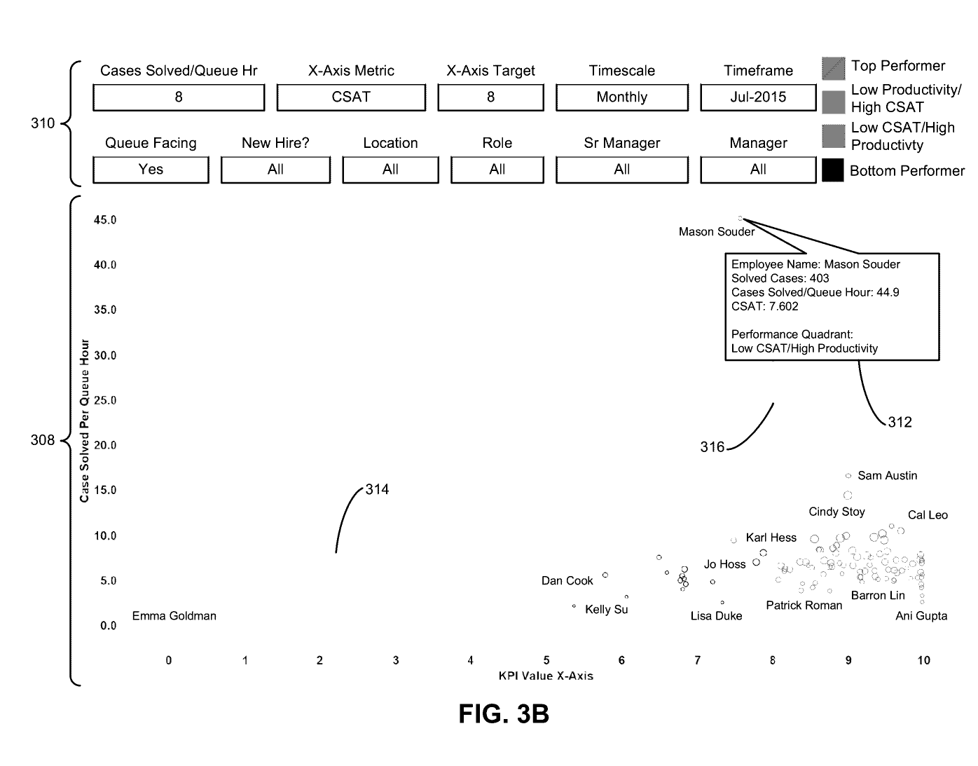

First, management apparatus 206 may display a ranking 220 of customer service representatives by quantitative metrics 224, qualitative metrics 226, and/or performance measurements 208. For example, management apparatus 206 may rank the customer service representatives in ascending or descending order of productivity KPI 214, quality KPI 218, and/or aggregate KPI 242. In turn, the ranking may allow users of GUI 204 to identify top, average, and bottom performers in the customer service representatives. Rankings of customer service representatives by KPIs are described in further detail below with respect to FIG. 3A.

Management apparatus 206 may also group the customer service representatives prior to generating ranking 220. For example, management apparatus 206 may group the customer service representatives by geographic location (e.g., office, building, city, state, country, region, continent, etc.), manager, senior manager, hire status (e.g., new hire or experienced), queue-facing status (e.g., primarily assigned customer-facing queue work or primarily managing people who perform customer-facing work), and/or role (e.g., supporting a particular product or customer need). In turn, the groupings may allow the performance of the customer service representatives to be assessed with respect to the same and/or different attributes. For example, the groupings may allow comparison of the performance of customer service representatives within the same team, office, or role, as well as the identification of similarities or differences in the activity of customer service representatives in different teams, offices, or roles.

Second, management apparatus 206 may display a chart 222 in GUI 204, such as a chart of the two-dimensional performance measurement represented by aggregate KPI 242 for one or more groupings of the customer service representatives. For example, chart 222 may include a first axis representing productivity KPI 214 and a second axis representing quality KPI 218. As a result, chart 222 may provide a visualization that allows the performance of the customer service representatives to be evaluated along multiple dimensions, as described in further detail below with respect to FIG. 3B.

Third, management apparatus 206 may display data 228 associated with quantitative metrics 224, qualitative metrics 226, performance measurements 208, and/or the customer service representatives. For example, data 228 may include the names, locations, managers, senior managers, hire statuses, queue-facing statuses, roles, and/or other attributes of the customer service representatives. Data 228 may also include aggregated metrics, performance measurements, and/or statistics related to customer service representative performance, such as overall or average solved cases, queue hours, CSATs 216, and/or performance measurements 208 for a given team, location, manager, role, hire status, queue-facing status, and/or other grouping of customer service representatives. As described in further detail below with respect to FIGS. 3A-3B, data 228 may further be displayed based on a position of a cursor in GUI 204.

To facilitate analysis of ranking 220, chart 222, and/or data 228, management apparatus 206 may provide one or more filters 230. For example, management apparatus 206 may display filters 230 for different groupings of customer service representatives; values of quantitative metrics 224, qualitative metrics 226, and/or performance measurements 208; and/or timescales and/or timeframes associated with quantitative metrics 224, qualitative metrics 226, performance measurements 208, and/or data 228. After one or more filters 230 are selected by a user interacting with GUI 204, management apparatus 206 may use filters 230 to update ranking 220, chart 222, and/or data 228.

Finally, management apparatus 206 may update one or more components of GUI 204 based on targets 232 for quantitative metrics 224, qualitative metrics 226, and/or performance measurements 208. For example, management apparatus 206 may provide user-interface elements for specifying a target value for productivity KPI 214, quality KPI 218, and/or other KPI for a given group of customer service representatives. Management apparatus 206 may then update representations of the KPI and/or customer service representatives in ranking 220, chart 222, and/or data based on targets 232 to facilitate identification of customer service representatives that are overperforming and/or underperforming with respect to targets 232. Consequently, the system of FIG. 2 may improve customer service interaction by providing tools and insights for evaluating and managing the performance of customer service representatives across multiple KPIs, groupings, and/or other attributes of the customer service representatives.

Those skilled in the art will appreciate that the system of FIG. 2 may be implemented in a variety of ways. First, analysis apparatus 202, GUI 204, management apparatus 206, and/or data repository 134 may be provided by a single physical machine, multiple computer systems, one or more virtual machines, a grid, one or more databases, one or more filesystems, and/or a cloud computing system. Analysis apparatus 202, GUI 204, and management apparatus 206 may additionally be implemented together and/or separately by one or more hardware and/or software components and/or layers.

Second, quantitative metrics 224 and qualitative metrics 226 may be obtained and/or aggregated from various sources. For example, quantitative metrics 224 and qualitative metrics 226 may be obtained from customer service tools, monitoring tools, feedback mechanisms, survey mechanisms, internal performance reviews, cloud-based data sources, offline data sources, third-party data sources, social media websites, review websites, and/or other mechanisms for tracking the productivity and/or quality of work of customer service representatives. Such tools and/or mechanisms may be created, maintained, and/or deployed separately for different customer service roles, teams, locations, or use cases, or one or more tools or mechanisms may be shared by multiple customer service roles, teams, locations, or use cases.

FIG. 3A shows an exemplary screenshot in accordance with the disclosed embodiments. More specifically, FIG. 3A shows a screenshot of a GUI, such as GUI 204 of FIG. 2. As described above, the GUI may be used to characterize, assess, and manage the performance of customer service representatives, such as customer service representatives for online professional network 118 of FIG. 1 and/or another product, application, or service.

As shown in FIG. 3A, the GUI includes a table 302 of metrics and/or KPIs for a number of customer service representatives. Within table 302, two sets of customer service representatives are grouped under two different managers (i.e., “Josh Jones” and “Amy Smith”), which are specified in the first column of table 302. The next three columns of table 304 identify a queue-facing status (i.e., “Queue Facing Flag”), hire status (i.e., “New Hire Flag”), and name (i.e., “Employee Name”) of each customer representative.

Subsequent columns of table 302 specify metrics and/or KPIs for the customer service representatives, including the number of queue hours (i.e., “Queue Hr”), number of non-queue hours (i.e., “Non Queue Hr”), queue time utilization (e.g., queue hours divided by total hours), number of solved cases (i.e., “Solved Case”), cases solved per queue hour (i.e., “Case Solved Per Q-Hr”), and number of distinct solved cases (i.e., “Distinct Solved”) for each customer service representative. The metrics and/or KPIs may also include a reopen rate (e.g., number of reopened cases divided by number of solved cases), a number of reopened cases (i.e., “Reopened Case”), a number of cases routed away from the representative (i.e., “Routed Case”), a number of open cases (i.e., “Open Case”), and a number of handled cases (i.e., “Handled Case”) for the customer service representative. Finally, the metrics and/or KPIs may include an average CSAT (i.e., “Rep Avg Sat Rating”) for the customer service representative, when one or more CSATs have been provided for the customer service representative.

Rows of table 302 may be sorted by increasing or decreasing values in the columns of the table. As shown in FIG. 3A, the rows of table 302 under each manager are sorted in decreasing order of cases solved per queue hour. In other words, table 302 may rank two groupings of customer service representatives under two different managers by the cases solved per queue hour. A user may change the ranking in each group by clicking, double-clicking, and/or otherwise interacting with the heading of a column to sort the rows by increasing or decreasing values in the column.

Different views of data in table 302 may be generated by applying one or more parameters 304 to the data. Parameters 304 may include one or more targets for the KPIs, such as an expected number of queue hours (i.e., “Expected Queue Hrs”) and/or a number of cases solved per queue hour (i.e., “Cases Solved/Queue Hr”). The GUI may update the colors of values in table 302 in response to the specified targets. For example, values in a given row of table 302 may be colored orange if one or more KPIs for the corresponding customer service representative are below the specified targets (i.e., 15 queue hours and 5 cases solved per queue hour) and blue if all KPIs for the customer service representative are above the specified targets. By changing the values of the targets through parameters 304 and viewing corresponding changes to data in table 302, the user may easily identify customer service representatives who fall behind the targets, as well as customer service representatives who exceed the targets. In turn, visual feedback provided by table 304 based on the targets may allow the user to identify suitable targets for different groups and/or subsets of the customer service representatives.

Parameters 304 may also include a number of filters for data in table 302. The filters may include time-based filters, such as a year, timescale, and/or timeframe associated with the data. The filters may also specify attributes of customer service representatives, such as a queue-facing status (e.g., queue-facing and/or non-queue-facing), hire status (e.g., new and/or experienced hire), location (e.g., office, city, state, country, continent, etc.), customer service role (e.g., supporting a specific product or function), senior manager (i.e., “Sr Manager”), and/or manager of the customer service representatives. After a filter is specified using the corresponding user-interface element, table 302 may be updated to display data that matches the filter. For example, table 302 may include attributes, metrics, and/or KPIs for customer service representatives in the most recent week of the year of 2015 who have queue-facing statuses, are both new and experienced hires, are in all locations, occupy all customer service representative roles, and are assigned to any senior manager or manager.

Data in table 302 may further be updated based on the position of a cursor in the GUI. For example, table 302 may include a user-interface element 306 that is adjacent to an element (“14%”) in a row of table 302. User-interface element 306 may be displayed when the cursor is positioned over the value. Data in user-interface element 306 may include a new hire status (“No”), a queue facing status (“Yes”), a time period (“Sep. 13-19, 2015”), an employee name (“Karen Roy”), a manager (“Josh Jones”), a performance (“Exceeds Targets”), a total solved cases (“1,466”), and/or a total queue hours (“297”) for the customer service representative represented by the row. As the cursor is moved over elements in other rows of table 302, the position of user-interface element 306 may shift to be adjacent to the element over which the cursor is currently positioned, and values in user-interface element 306 may be updated to reflect data associated with the corresponding customer service representative. Consequently, user-interface element 306 may allow the user to obtain additional information about specific customer service representatives in table 302 and glean insights related to the productivity, efficiency, effectiveness, and/or performance of different groups of customer service representatives over time.

FIG. 3B shows an exemplary screenshot in accordance with the disclosed embodiments. Like FIG. 3A, FIG. 3B shows a GUI such as GUI 204 of FIG. 2. Unlike the GUI of FIG. 3A, the GUI of FIG. 3B includes a chart 308 of a two-dimensional performance measurement for a group of customer service representatives. The y-axis of chart 308 represents a productivity KPI that is calculated as the number of cases solved per queue hour for the customer service representatives. The x-axis of chart 308 represents an additional KPI that is specified in a set of parameters 310 for data in chart 308. For example, parameters 310 may include a user-interface element that allows a user to select the metric represented by the x-axis (i.e., “X-Axis Metric”) as a CSAT, number of queue hours, number of solved cases, reopen rate, and/or other KPI for the customer service representatives. As a result, the two-dimensional performance measurement may include the productivity KPI as one dimension and the additional KPI as another dimension.

Representations of the two-dimensional performance measurement may then be displayed within chart 308 based on the values of the productivity KPI and the additional KPI for the customer service representatives. Each customer service representative is represented by a colored circle in the chart, with the horizontal position of the circle reflecting the value of the additional KPI for the customer service representative and the vertical position of the circle reflecting the value of the productivity KPI for the customer service representative. The size of the circle may represent the overall number of cases solved by the customer service representative, with a larger circle indicating a large number of solved cases and a smaller circle indicating a smaller number of solved cases.

As with parameters 304 of FIG. 3A, additional parameters 310 may be used to generate different views of data in chart 308. First, parameters 310 may include filters for a queue-facing status (i.e., “Queue Facing”), hire status (i.e., “New Hire”), location, role, senior manager (i.e., “Sr Manager”), and/or manager for the customer service representatives. The filters may also include a timescale and/or timeframe associated with the displayed data. After a filter is specified using the corresponding user-interface element, chart 308 may be updated to display data that matches the filter. For example, chart 308 may include representations of two-dimensional performance measurements from a monthly period spanning July 2015 for customer service representatives who have queue-facing statuses, are both new and experienced hires, are in all locations, occupy all customer service representative roles, and are assigned to any senior manager or manager.

Second, parameters 310 may include targets for the KPIs represented by the axes of chart 308. For example, the parameters may allow the user to specify a target for the productivity KPI (i.e., “Cases Solved/Queue Hr”) and a target for the KPI represented by the x-axis (i.e., “X-Axis Target”). The target for the productivity KPI may be shown as a horizontal line 314 in chart 308, and the target for the KPI represented by the x-axis may be shown as a vertical line 316 in chart 308. Lines 314-316 may thus indicate thresholds for the KPIs that divide chart 308 into quadrants representing different levels of performance for the customer service representatives. For example, lines 314-316 may divide chart 308 into an upper left quadrant that represents a below-target CSAT and an above-target productivity KPI, a lower left quadrant that represents a below-target CSAT and a below-target productivity KPI, a lower right quadrant that represents an above-target CSAT and a below-target productivity KPI, and an upper right quadrant that represents an above-target CSAT and an above-target productivity KPI.

Representations of two-dimensional performance measurements in chart 308 may additionally be updated based on the targets. In particular, the color of each circle in chart 308 may reflect the quadrant in which the circle is found. For example, a circle in the upper right quadrant may be colored green to indicate a top performer who is above target in both CSAT and productivity KPI, a circle in the lower right quadrant may be colored orange to indicate a below-target productivity KPI and above-target CSAT, a circle in the upper left quadrant may be colored blue to indicate a below-target CSAT and above-target productivity KPI, and a circle in the lower left quadrant may be colored purple to indicate a bottom performer who is below target in both CSAT and productivity KPI. By changing the values of the targets through parameters 310 and viewing corresponding changes to lines 314-316 and representations of the two-dimensional performance measurement in chart 308, the user may easily identify customer service representatives who fall behind one or more targets, as well as customer service representatives who exceed one or more targets.

In turn, visual feedback provided by chart 308 based on parameters 310 may allow the user to identify suitable targets for different groups and/or subsets of the customer service representatives. For example, the user may use information in chart 308 to select targets as median or “average” values for the productivity KPI and additional KPI so that half of all customer service representatives that match the filters in parameters 310 fall below the targets and half of the customer service representatives exceed the targets.

Chart 308 may additionally be updated based on the position of a cursor in the GUI. For example, chart 308 may include a user-interface element 312 that is adjacent to a representation of a two-dimensional performance measurement in the upper left quadrant of chart 308. User-interface element 312 may be displayed when the cursor is positioned over the representation. Data in user-interface element 312 may include an employee name (“Mason Souder”), a number of solved cases (“403”), a number of cases solved per queue hour (“44.9”), an average CSAT (“7.602”), and a performance quadrant (“Low CSAT/High Productivity”) for the customer service representative associated with the two-dimensional performance measurement. As the cursor is moved over other representations in chart 308, the position of user-interface element 312 may shift to be adjacent to the element over which the cursor is currently positioned, and values in user-interface element 312 may be updated to reflect data associated with the corresponding customer service representative. Consequently, user-interface element 312 may allow the user to obtain additional information about specific customer service representatives through chart 308 and glean insights related to the productivity, efficiency, effectiveness, and/or performance of different groups of customer service representatives over time.

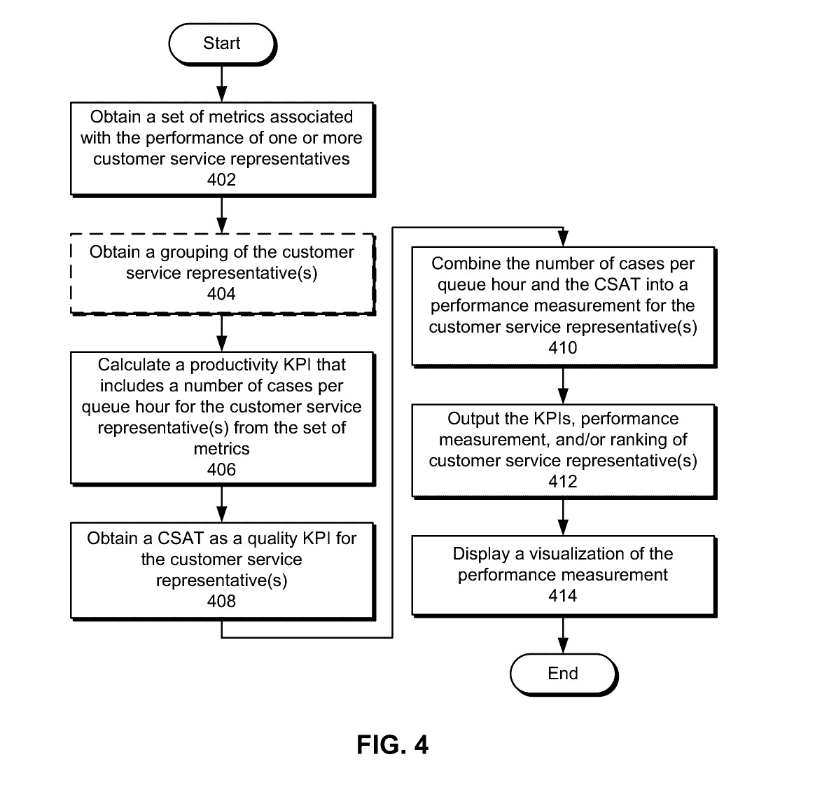

FIG. 4 shows a flowchart illustrating the processing of data in accordance with the disclosed embodiments. More specifically, FIG. 4 shows a flowchart of performing multidimensional characterization of customer service dynamics. In one or more embodiments, one or more of the steps may be omitted, repeated, and/or performed in a different order. Accordingly, the specific arrangement of steps shown in FIG. 4 should not be construed as limiting the scope of the embodiments.

Initially, a set of metrics associated with the performance of one or more customer service representatives is obtained (operation 402). The metrics may include both qualitative and quantitative metrics. The qualitative metrics may include one or more CSATs, ratings, and/or scores for the performance of each customer service representative, and the quantitative metrics may include a number of cases per unit time and/or a number of queue hours per unit time for the customer service representative.

A grouping of the customer service representative(s) is also optionally obtained (operation 404). For example, the grouping may specify one or more locations, managers, senior managers, hire statuses, queue-facing statuses, roles, and/or other attributes of the customer service representative(s).

Next, a productivity KPI that includes a number of cases per queue hour for the customer service representative(s) is calculated from the metrics (operation 406). To calculate the productivity KPI, a number of cases per unit time and a number of queue hours per unit time may be obtained for the customer service representative(s) from the set of metrics, and the number of cases per unit time may be divided by the number of queue hours per unit time to obtain the number of cases per queue hour for the customer service representative(s). The number of cases per unit time may include a number of solved cases, reopened cases, handled cases, and/or routed cases for some or all of the customer service representatives.

A CSAT is also obtained as a quality KPI for the customer service representative(s) (operation 408). For example, the quality KPI may be obtained as an average CSAT and/or weighted combination of CSATs or other scores for each customer service representative. Alternatively, multiple CSAT values or scores may be included in the quality KPI for the customer service representative.

The number of cases per queue hour and CSAT are then combined into a performance measurement for the customer service representative(s) (operation 410). For example, the number of cases per queue hour and CSAT may be combined into a two-dimensional performance measurement and/or aggregated into a performance score for the customer service representative(s).

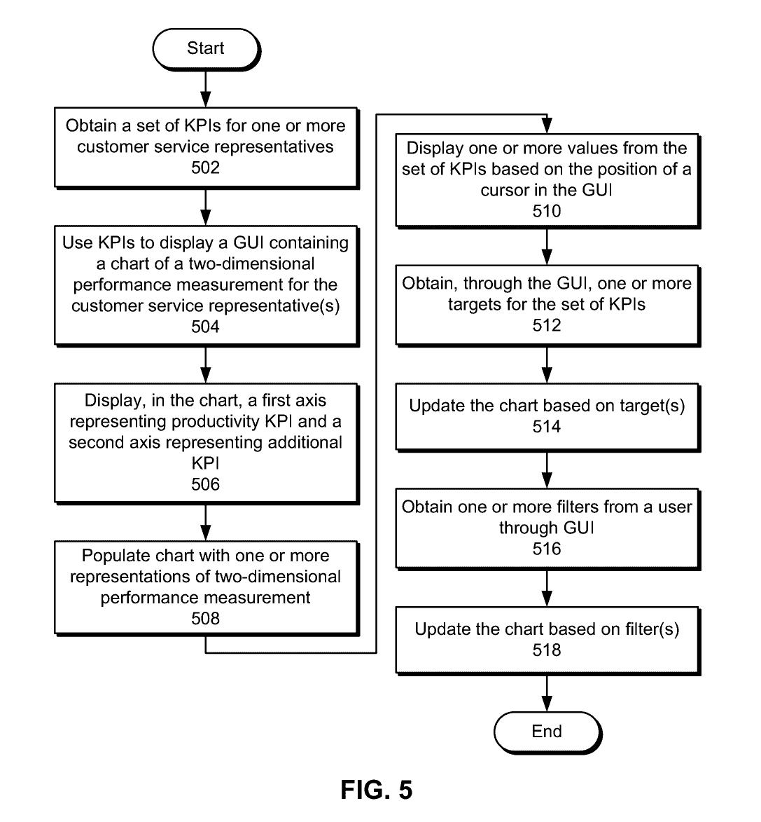

Finally, the KPIs, performance measurement, and/or a ranking of the customer service representative(s) by the KPIs and/or performance measurement are outputted (operation 412) for use in managing the performance of the customer service representative(s). For example, the KPIs and/or performance measurement for a given grouping of customer service representatives may be displayed in a table, and rows in the table may be ordered by decreasing order of KPI and/or performance measurement. A visualization of the performance measurement may additionally be displayed (operation 414). For example, the visualization may include a chart of the two-dimensional performance measurement, as described in further detail below with respect to FIG. 5.

FIG. 5 shows a flowchart illustrating the process of providing a graphical user interface (GUI) on a computer system in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

First, a set of KPIs for one or more customer service representatives is obtained (operation 502). The KPIs may include quantitative and qualitative metrics that characterize the performance of the customer service representative(s). For example, the KPIs may include a productivity KPI that is represented by a number of cases per queue hour (e.g., solved cases, reopened cases, handled cases, and/or routed cases), a quality KPI that is represented by one or more CSATs or scores, and/or additional KPIs such as a number of queue hours, a number of solved cases, and/or a reopen rate.

Next, the set of KPIs is used to display a GUI containing a chart of a two-dimensional performance measurement for the customer service representative(s) (operation 504). For example, the two-dimensional performance measurement may include a quantitative metric such as the productivity KPI in one dimension and a qualitative metric such as CSAT in the other dimension. In another example, the two-dimensional performance measurement may include the productivity KPI in one dimension and an additional KPI in the other dimension.

A first axis representing the productivity KPI and a second axis representing the additional KPI are also displayed in the chart (operation 506), and the chart is populated with one or more representations of the two-dimensional performance measurement (operation 508). For example, the chart may include circles, lines, bars, shapes, clusters, and/or other graphical representations of values of the two-dimensional performance measurement and/or other KPIs or metrics for the customer service representative(s). The position of each graphical representation may reflect the value of the two-dimensional performance measurement along the corresponding axis of the chart, and other attributes (e.g., size, shape, color, shading, etc.) of the graphical representation may reflect the values of other KPIs and/or attributes for the corresponding customer service representative.

One or more values from the set of KPIs is further displayed based on the position of a cursor in the GUI (operation 510). For example, a number of solved cases, the productivity KPI, and/or the additional KPI may be displayed next to a graphical representation of the two-dimensional performance measurement in the chart when the cursor is positioned over the graphical representation.

Next, one or more targets for the set of KPIs is obtained through the GUI (operation 512), and the chart is updated based on the target(s) (operation 514). For example, the targets may be obtained through one or more user-interface elements (e.g., text boxes, sliders, drop-down menus, radio buttons, etc.) in the GUI, and one or more thresholds representing the target(s) may be displayed as lines in the chart. The color, shape, shading, and/or other attribute of each representation of the two-dimensional performance measurement in the chart may then be modified based on a comparison of the two-dimensional performance measurement with the threshold(s).

Similarly, one or more filters are obtained from a user through the GUI (operation 516), and the chart is updated based on the filter(s) (operation 518). The filters may include timescales, timeframes, queue-facing statuses, new hire statuses, locations, roles, senior managers, managers, and/or other attributes or groupings of the customer service representatives. After the filters are specified, the chart may be updated with data from customer service representatives that match the filters.

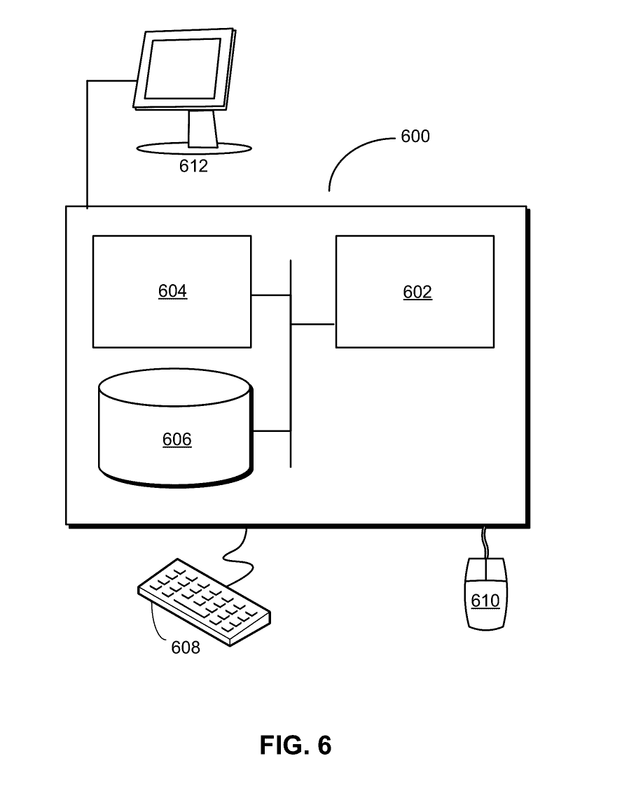

FIG. 6 shows a computer system 600 in accordance with an embodiment. Computer system 600 includes a processor 602, memory 604, storage 606, and/or other components found in electronic computing devices. Processor 602 may support parallel processing and/or multi-threaded operation with other processors in computer system 600. Computer system 600 may also include input/output (I/O) devices such as a keyboard 608, a mouse 610, and a display 612.

Computer system 600 may include functionality to execute various components of the present embodiments. In particular, computer system 600 may include an operating system (not shown) that coordinates the use of hardware and software resources on computer system 600, as well as one or more applications that perform specialized tasks for the user. To perform tasks for the user, applications may obtain the use of hardware resources on computer system 600 from the operating system, as well as interact with the user through a hardware and/or software framework provided by the operating system.

In one or more embodiments, computer system 600 provides a system for processing data. The system may include an analysis apparatus that obtains a set of metrics associated with a performance of one or more customer service representatives. Next, the analysis apparatus may calculate a productivity KPI from the set of metrics as a number of cases (e.g., solved cases, reopened cases, handled cases, and/or routed cases) per queue hour for the customer service representative(s). The analysis apparatus may also obtain a CSAT for the customer service representative(s) as a quality KPI for the customer service representative(s).

The system may also include a management apparatus that outputs the productivity KPI and/or quality KPI for use in managing the performance of the customer service representative(s). The management apparatus may also display a GUI containing a ranking of one or both KPIs for the customer service representative(s). The management apparatus may further use the KPIs to display, in the GUI, a chart of a two-dimensional performance measurement. The chart may include a first axis representing the productivity KPI and a second axis representing the quality KPI and/or another KPI for the customer service representative(s).

In addition, one or more components of computer system 600 may be remotely located and connected to the other components over a network. Portions of the present embodiments (e.g., analysis apparatus, management apparatus, data repository, etc.) may also be located on different nodes of a distributed system that implements the embodiments. For example, the present embodiments may be implemented using a cloud computing system that provides multidimensional characterization of and insights related to customer service dynamics between a set of remote users and a set of customer service representatives.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a set of key performance indicators (KPI) for one or more customer service representatives, wherein the set of KPIs comprises a number of cases per queue hour;
using the set of KPIs to display, by a computer system, a graphical user interface (GUI) comprising a chart of a two-dimensional performance measurement for the one or more customer service representatives; and
displaying, in the chart, a first axis representing a productivity KPI comprising the number of cases per queue hour and a second axis representing an additional KPI from the set of KPIs.

2. The method of claim 1, further comprising:
obtaining, through the GUI, one or more targets for the set of KPIs; and
updating the chart based on the one or more targets.

3. The method of claim 2, wherein updating the chart based on the one or more targets comprises:
displaying one or more thresholds representing the one or more targets in the chart.

4. The method of claim 3, wherein updating the chart based on the one or more targets further comprises:
modifying one or more representations of the two-dimensional performance measurement in the chart based on the one or more thresholds.

5. The method of claim 4, wherein modifying the one or more representations of the two-dimensional performance measurement in the chart based on the threshold comprises:
modifying a color of the one or more representations based on a comparison of the two-dimensional performance measurement with the one or more thresholds.

6. The method of claim 1, further comprising:
displaying one or more values from the set of KPIs based on a position of a cursor in the GUI.

7. The method of claim 6, wherein the one or more values comprises at least one of:
a number of solved cases;
the productivity KPI; and
the additional KPI.

8. The method of claim 1, wherein the number of cases per queue hour comprises at least one of:
a number of solved cases;
a number of reopened cases;
a number of handled cases; and
a number of routed cases.

9. The method of claim 8, wherein the one or more filters comprise at least one of:
a location;
a manager;
a senior manager;
a hire status;
a queue-facing status; and
a role.

10. The method of claim 1, wherein obtaining the set of KPIs for the one or more customer service representatives comprises:
calculating the productivity KPI by dividing a number of cases per unit time for the one or more customer service representatives by a number of queue hours per unit time for the one or more customer service representatives; and
including the productivity KPI in the two-dimensional performance measurement for the one or more customer service representatives.

11. The method of claim 1, wherein the additional KPI is at least one of:
a customer satisfaction score (CSAT);
a number of queue hours;
a number of solved cases; and
a reopen rate.

12. An apparatus, comprising:
one or more processors; and
memory storing instructions that, when executed by the one or more processors, cause the apparatus to:
obtain a set of key performance indicators (KPI) for one or more customer service representatives, wherein the set of KPIs comprises a number of cases per queue hour;
using the set of KPIs to display a graphical user interface (GUI) comprising a chart of a two-dimensional performance measurement for the one or more customer service representatives; and
display, in the chart, a first axis representing a productivity KPI comprising the number of cases per queue hour and a second axis representing an additional KPI from the set of KPIs.

13. The apparatus of claim 12, wherein the memory further stores instructions that, when executed by the one or more processors, cause the apparatus to:
obtain, through the GUI, one or more targets for the set of KPIs; and
update the chart based on the one or more targets.

14. The apparatus of claim 13, wherein updating the chart based on the one or more targets comprises:
displaying one or more thresholds representing the one or more targets in the chart; and
modifying one or more representations of the two-dimensional performance measurement in the chart based on the one or more thresholds.

15. The apparatus of claim 14, wherein modifying the one or more representations of the two-dimensional performance measurement in the chart based on the threshold comprises:
modifying a color of the one or more representations based on a comparison of the two-dimensional performance measurement with the one or more thresholds.

16. The apparatus of claim 12, wherein the memory further stores instructions that, when executed by the one or more processors, cause the apparatus to:
display one or more values from the set of KPIs based on a position of a cursor in the GUI.

17. The apparatus of claim 12, wherein the memory further stores instructions that, when executed by the one or more processors, cause the apparatus to:
obtain one or more filters from a user through the GUI; and
update the chart based on the one or more filters.

18. A system, comprising:
an analysis module comprising a non-transitory computer-readable medium comprising instructions that, when executed by one or more processors, cause the system to obtain a set of key performance indicators (KPI) for one or more customer service representatives, wherein the set of KPIs comprises a number of cases per queue hour; and
a management module comprising a non-transitory computer-readable medium comprising instructions that, when executed by the one or more processors, cause the system to:
use the set of KPIs to display a graphical user interface (GUI) comprising a chart of a two-dimensional performance measurement for the one or more customer service representatives; and
display, in the chart, a first axis representing a productivity KPI comprising the number of cases per queue hour and a second axis representing an additional KPI from the set of KPIs.

19. The system of claim 18, wherein the non-transitory computer-readable medium of the management module further comprises instructions that, when executed by the one or more processors, cause the system to:
obtain, through the GUI, one or more targets for the set of KPIs; and
update the chart based on the one or more targets.

20. The system of claim 19, wherein updating the chart based on the one or more targets comprises:
displaying one or more thresholds representing the one or more targets in the chart; and
modifying one or more representations of the two-dimensional performance measurement in the chart based on the one or more thresholds.
